(19) United States
(12) Patent Application Publication
(10) Pub. No.: US 2007/0126496 A1
(43) Pub. Date: Jun. 7, 2007

(54) Semiconductor integrated circuit

(75) Inventors: Akihiro Kawamura, Osaka (JP); Keiichi Fujii, Shiga (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/605,321

(22) Filed: Nov. 29, 2006

(30) Foreign Application Priority Data
Dec. 2, 2005 (JP) 2005-349109

(51) Int. Cl. G05F 1/10

(52) U.S. Cl. 327/541

(57) ABSTRACT

A semiconductor integrated circuit is provided with a signal processing circuit which operates based on a first reference voltage and processes a voice signal, an output amplifier which amplifiers the voice signal, and a pair of BTL output-type output amplifiers which operates based on a second voltage, amplifies the voice signal, and supplies the amplified signal to a speaker. And further, the integrated circuit is provided with a voltage comparator which compares the second reference voltage and a predetermined voltage and a precharging circuit which makes the first reference voltage rapidly reach a stable voltage for a time period during which the second reference voltage reaches the predetermined voltage based on the comparison results from the voltage comparator.

### BACKGROUND OF THE INVENTION

1. Field of the Invention

The present invention relates to a semiconductor circuit provided with an amplifier circuit for driving a speaker which produces, for example, BTL (balanced transformer less) output.

2. Background Art

With the enhanced performance of information terminal equipment such as notebook PCs (notebook personal computers), DVCs (digital video cameras), DSCs (digital still cameras), PDAs (personal digital assistants), cellular phones, and so on, increased power consumption has become a problem in recent years.

Although the life of rechargeable batteries has also been prolonged year by year, the functions of digital equipment have been increased more and more in recent years and hence, under the present circumstances, the capacity of batteries has not drawn even with the recent increase in the functions of digital equipment. This also has presented the important problems that semiconductor integrated circuits mounted on them have to contribute to reduction in power consumption and the prolonging of time when digital equipment provided with semiconductor integrated circuits can be used.

Hence, as a method for reducing power consumption, a method for controlling voice circuits with high current consumption is used. In the above information terminal equipment and so on, cases where voice output is required at all times are few and in general, needed voice is outputted or inputted on an as-needed basis. That is, since there are time periods during which voice processing circuits are not operated even while information terminal equipment are operated, a method is generally used in which during that periods, the power supplies of semiconductor integrated circuits including the voice processing circuits are turned off or when standby functions are provided, power consumption is reduced by using the standby functions.

Furthermore, since output amplifiers are required to have the capability of driving loads and consume much current as compared with amplifiers for use in ordinary signal processing, another method is also used in which power consumption is reduced by using power-saving functions for use in turning on or off only output amplifiers.

However, in such information terminal equipment and so on, although constant voltage, internal power supply voltage, and the like are generated by using batteries as power supplies and regulators, not a few fluctuations (hereinafter referred to as power ripples) occur in those voltages. In order to reduce the ill effect of such ripples, semiconductor integrated circuits including voice processing circuits have stabilizing capacitors for use in dealing with variations in reference voltages fed to internal circuits and filters for use in passing only voice bands.

Since their capacitance values are high in general, such components cannot be included in semiconductor integrated circuits and are, therefore, externally connected to the circuits. Because of this, due to switching between the ON state and the OFF state at power supplies and when standby functions are provided, due to switching between the ON state and the OFF state of the functions, a time for charging is required each time to secure the capacitance.

In particular, since the stabilizing capacitors for use in reducing power ripples and the filters for use in passing only voice bands, and so on have high capacitance values, there is a tendency that it takes much time while the charging for securing the above capacitance values is completed at the times when power supplies are in the ON state and the standby functions are in the OFF state, and then voltages become stable. Particularly, in stabilizing capacitors, when signals are about to be outputted by turning off power-saving functions of output amplifiers while power supplies are turned on or standby functions are turned off and reference voltages then become stable, difference in level occurs in signal output and then appears as pop noise, thereby voice quality degrades. On account of this, there is a need to wait for reference voltage stability.

As described above, when it takes much time while voice output modes are brought about at information terminal equipment, then power supplies are turned on, and voice is outputted, users feel that responses are poor, and hence the values of the products significantly decrease.

Therefore a technique is generally used in which terminals to which capacitors causing the problem that it takes much time until such charging is conducted are connected are precharged (see, for example, Patent References 1 and 2).

FIG. 3 is a circuit diagram of an example of conventional semiconductor integrated circuits in which such precharging is conducted. In FIG. 3, reference numeral 100 denotes a semiconductor integrated circuit. Reference numeral 1 denotes an external capacitor for providing precharge timing. Reference numeral 2 denotes a resistor which constitutes a time constant circuit together with the capacitor 1 for providing precharge timing. Reference numeral 31 denotes a terminal to which the capacitor 1 for providing precharge timing is connected. Reference numeral 3 denotes a first resistor which divides a power supply voltage to generate a reference voltage VREF. Reference numeral 4 denotes a second resistor which divides the power supply voltage to generate the reference voltage VREF. Reference numeral 5 denotes an external capacitor for stabilizing reference voltage. Reference numeral 11 denotes a voltage comparator which compares a voltage at the terminal 31 and a given voltage and outputs a low-level or high-level signal according to the comparison results. Reference numeral 12 denotes a precharging circuit which is turned on or off with the low-level or high-level signal from the voltage comparator 11. Reference numeral 13 denotes a signal processing circuit which operates based on the reference voltage VREF. Reference numeral 16 denotes a current source (a resistor may be used instead). Reference numeral 17 denotes a standby control switch. Reference numeral 21 denotes a power supply externally provided. Reference numeral 32 denotes a terminal to which the capacitor 5 for stabilizing reference voltage is connected. Reference numeral 33 denotes a voice signal input terminal. Reference numeral 34 denotes a voice signal output terminal. Reference numeral 51 denotes a voice signal output amplifier which operates based on the reference voltage VREF. Reference numeral 61 denotes a buffer which supplies the reference voltage VREF to the output amplifier 51 and the signal processing circuit 13. Reference numeral 301 denotes an interconnection for the reference voltage VREF outputted from the buffer 61 which receives the voltage (reference voltage) divided by the first resistor 3 and the second resistor 4. Reference numeral 15 denotes a control signal generator which externally controls the standby control switch 17 and the output amplifier 51 through the use of low-level or high-level signals. Reference alphanumeric S1 denotes a standby control signal outputted from the control signal generator 15. Reference alphanumeric S2 denotes a power-saving control signal outputted from the control signal generator 15.

FIG. 5 is a circuit diagram of an example of the precharging circuit. In FIG. 5, the resistance values of voltage dividing resistors R₁ and R₂ are adjusted such that a potential at a point A becomes equal to the reference voltage VREF. In addition, a current IPR is controlled based on the comparison results from the voltage comparator 11. In a case where a standby function is provided, when the power supply has changed from the OFF state to the ON state, that is, when the standby function has been turned off, the current IPR flows at the precharging circuit for only several tens of milliseconds. As a result, a VREF terminal is rapidly charged with a voltage generated through internal voltage division done by the resistors via an emitter follower, thereby precharging is done. It becomes possible for a voltage at the VREF terminal TM1 at reach the reference voltage VREF for about 10 to 20 msec. In a case where no precharging circuit is provided, the voltage at the VREF terminal rises based on a time constant determined by a resistor R_{VREF} and an external capacitor C_{VREF} for stabilizing reference voltage and it takes a long time until the voltage reaches the reference voltage VREF.

In this circuit, the resistor R_{VREF} corresponds to the resistor 4 of FIG. 3, the capacitor C_{VREF} for stabilizing reference voltage corresponds to the capacitor 5 for stabilizing reference voltage of FIG. 3, the VREF terminal TM1 corresponds to the terminal 32 of FIG. 3, and a buffer BF corresponds to the buffer 61 of FIG. 3.

FIG. 4 is a graph showing variations in voltage at the individual components of FIG. 3.

The operation of the semiconductor integrated circuit having the above configuration will be described below with reference to FIGS. 3 and 4.

Initially, the power supply 21 is turned on.

Next, the switch 17 is closed with a standby control signal S1 shown in FIG. 4 at a time T1. As a result, power supply voltage is fed from the power supply 21 to the individual elements of the semiconductor integrated circuit 100 and the current source 16 is turned on.

After the current source 16 has been turned on, a voltage VX at the terminal 31 to which the capacitor 1 for providing precharge timing is connected rises gradually from the time T1 based on a time constant determined by the capacitor 1 for providing precharge timing and the resistor 2 as shown in FIG. 4. The initial value of the voltage VX at the terminal 31 is 0 V. Incidentally, a time constant represented by letter τ is the product of the resistance of a resistor and the capacitance value of a capacitor and has the dimension of time. At about 3 τ to 5 τ, voltage becomes stable.

The voltage comparator 11 compares the voltage VX at the connecting terminal 31 for the capacitor 1 for providing precharge timing and a given voltage VC. As a result,

when the voltage VX at the terminal 31≦the voltage VC, an output from the voltage comparator 11 is at the high level and

when the voltage VX at the terminal 31≧the voltage VC, an output from the voltage comparator 11 is at the low level. That is, the output is at the high level for a time period from the time T1 when a standby control signal has been brought to the high level to a time T2 when the voltage VX at the terminal 31 exceeds the voltage VC.

Then the precharging circuit 12 is controlled with the output voltage from the voltage comparator 11 such that when the output is at the high level, the precharging circuit 12 is turned on (is operated) and when the output is at the low level, the precharging circuit 12 is turned off (is not operated). Therefore the precharging circuit 12 is turned on at the time T1 and turned off at the time T2.

For the time period (T2−T1) during which the precharging circuit 12 is in the ON state, the capacitor 5 for stabilizing reference voltage is precharged, the capacitor 5 for stabilizing reference voltage is rapidly charged, and as shown by the solid line, a voltage VY (equal to the reference voltage VREF) at the terminal 32 is rapidly raised up to a stable voltage VS. Therefore, as shown by the broken line, the voltage VY (equal to the reference voltage VREF) can be quickly brought to the stable state as compared with a case where precharging is not done. The time period (T2−T1) during which the precharging circuit 12 is in the ON state can be arbitrarily determined by changing the voltage VC compared with the voltage VX by the voltage comparator 11.

The signal processing circuit 13 and the output amplifier 51 operate based on the reference voltage VREF. Because of this, after the precharging circuit 12 has been turned off, that is, by turning on the output amplifier 51 with a power-saving control signal S2 outputted from the control signal generator 15 at time T3 subsequent to the time T2, a voice signal can be outputted from the output amplifier 51.

When the output amplifier has been turned on with the above timing without the provision of the precharging circuit, the reference voltage VREF is not stable as can also be seen from variations in the voltage VY at the terminal 32 (shown by the broken line) brought about when no precharging has been done, and therefore pop noise occurs from the output amplifier 51 at the time 3. In order to prevent the occurrence of pop noise, it is necessary to further delay the timing for the supply of the power-saving control signal S2.

In contrast, the use of the precharging circuit 12 makes it possible to shorten the time taken from the release of the standby state to the output of the power-saving control signal S2. Incidentally, the time (T2−T1) is set at ≦200 msec in general. The reason why the time T2−T1≦200 msec is that it is assumed that a time exceeding 200 msec brings about a feeling that a response produced during the operation of a terminal device including the integrated circuit is poor. In the case where such a precharging circuit is not provided, a time taken to stabilize the reference voltage VREF is generally 1 sec or longer.

As described above, since the reference voltage VREF is rapidly stabilized by providing the capacitor 1 for providing precharge timing to the outside of the semiconductor integrated circuit, it becomes possible to do precharging for any given time period. As a consequence, although it has generally taken several seconds to output a voice signal, the time can be shortened within 200 milliseconds, and hence the response is heightened. Accordingly, when the power supply has been turned off or brought to the standby state at the time of the nonuse of the semiconductor integrated circuit, and then the power supply has been turned on or the standby state has been released as well, voice signals can be outputted without impairment of the response.

Patent Reference 1: JP-A No. 2004-280805

Patent Reference 2: JP-A No. 8-79338

In recent years, there has been an increasing demand to further reduce the size of components and their production cost in the field of information terminal development in particular and soon, and hence it has become absolutely necessary to reduce the footprint of mounted components through reduction in the number of the components and the miniaturization of semiconductor integrated circuits. However, in the conventional configuration described above, it is necessary to provide such a dedicated terminal for use in the connection with the capacitor for providing precharge timing. The time period when the terminal functions is about 200 msec at most after the standby function has been turned off, following which the terminal does not function while the semiconductor integrate circuit is in its normal operation. And further, in cases where the terminals are high in number, a reduction in the area of the semiconductor integrated circuit does not naturally lead to a reduction in the size of its package, and hence the footprint of the mounted components cannot be reduced.

### SUMMARY OF THE INVENTION

Therefore an object of the present invention is to provide a semiconductor integrated circuit which is not required to include a dedicated terminal for use in providing the timing of the operation of a precharging circuit used for expediting the stabilization of a reference voltage and which can be used to reduce the size of a package and, therefore, reduce a footprint.

Moreover, another object of the invention is to provide a semiconductor integrated circuit in which the number of external components can be reduced.

In order to solve the problems described earlier, the semiconductor integrated circuit according to the invention includes a first internal circuit which operates based on a first reference voltage, a second internal circuit which operates based on a second reference voltage, a voltage comparator which compares the second reference voltage and a predetermined voltage, and a precharging circuit which makes the first reference voltage rapidly reach a stable voltage for a time period during which the second reference voltage reaches the predetermined voltage based on the comparison results from the voltage comparator.

According to such a configuration, since the timing of the operation of the precharging is obtained by comparing the second reference voltage used at the second internal circuit and the predetermined voltage, there is no need to provide a dedicated terminal to which an external capacitor is connected in order to providing the timing of the operation of the precharging circuit for use in expediting the stabilization of the first reference voltage, the size of the package for the circuit can be reduced, and therefore the footprint of mounted components can be reduced.

In this configuration, it is preferable that the first and second reference voltages be generated by first and second reference voltage generation circuits respectively, first and second capacitors for stabilizing reference voltage be added to the first and second reference voltage generation circuits respectively, and the precharging circuit made the first reference voltage rapidly reach the stable voltage by charging the first capacitor for stabilizing reference voltage through the supply of a current to the first reference voltage generation circuit.

According to the configuration, it is possible to use the second capacitor for stabilizing reference voltage as a capacitor for providing the timing for the control of precharging.

In the above configuration, the first reference voltage generation circuit comprises, for example, first and second resistors which generate the first reference voltage from their junction point by dividing a power supply voltage with the resistors connected in series with each other, the first capacitor for stabilizing reference voltage connected to the junction point of the first and second resistors, and a first buffer which supplies the first reference voltage fed from the junction point of the first and second resistors to the first internal circuit. And further, the second reference voltage generation circuit comprises, for example, third and fourth resistors which generate the second reference voltage from their junction point by dividing the power supply voltage with the resistors connected in series with each other, the second capacitor for stabilizing reference voltage connected to the junction point of the third and fourth resistor, and a second buffer which supplies the second reference voltage fed from the junction point of the third and fourth resistors to the second internal circuit.

In the above configuration, the first internal circuit includes, for example, a signal processing circuit which processes an inputted voice signal and an amplifier for voice output which receives an output signal from the signal processing circuit and operates based on the first reference voltage. And further, the second internal circuit includes, for example, a BTL output-type amplifier circuit for driving a speaker which receives an output signal from the signal processing circuit and which operates based on the second reference voltage.

The amplifier circuit for driving the speaker comprises, for example, an inverter which inverts an output signal from the signal processing circuit, a first amplifier for driving the speaker to which an output signal from the inverter and the second reference voltage are supplied and a second amplifier for driving the speaker to which an output signal from the signal processing circuit and the second reference voltage are supplied. The speaker is connected between the output end of the first amplifier for driving the speaker and the output end of the second amplifier for driving the speaker.

According to the invention, there is no need to provide a dedicated terminal in order to provide the timing of the operation of the precharging circuit for use in expediting the stabilization of the reference voltage, the size of the package for the circuit can be reduced, and therefore the footprint thereof can be reduced.

In addition, by using the capacitor for stabilizing the reference voltage as a capacitor for providing the timing for the precharging, the number of the components can be further reduced and the number of the terminals can also be reduced.

### BRIEF DESCRIPTION OF THE DRAWINGS

FIG. 1 is a block diagram of the configuration of a semiconductor integrated circuit according to a first embodiment of the present invention;

FIG. 2 is a graph showing variations in voltage at the individual portions of the semiconductor integrated circuit of FIG. 1;

FIG. 3 is a block diagram of the configuration of a conventional semiconductor integrated circuit;

FIG. 4 is a graph showing variations in voltage at the individual portions of the semiconductor integrated circuit of FIG. 3; and

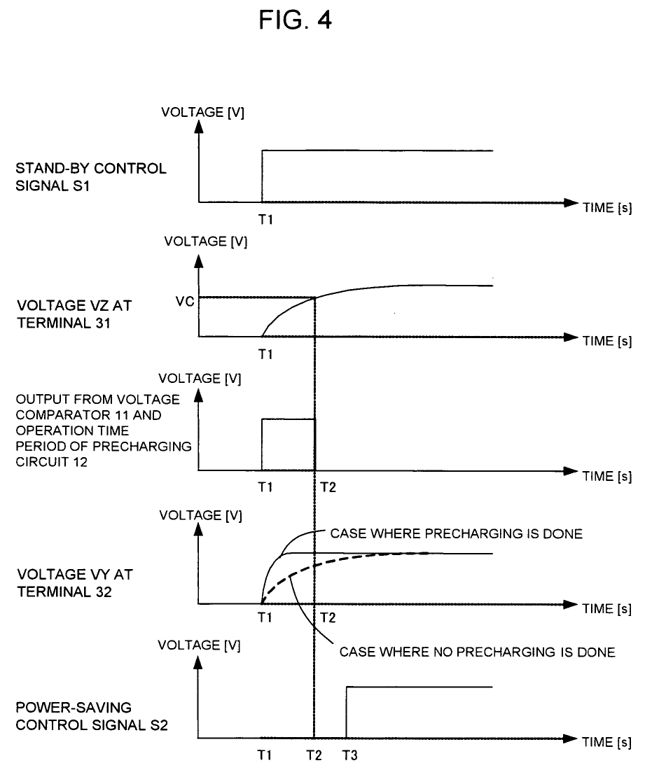

FIG. 5 is a circuit diagram of an example of a precharging circuit.

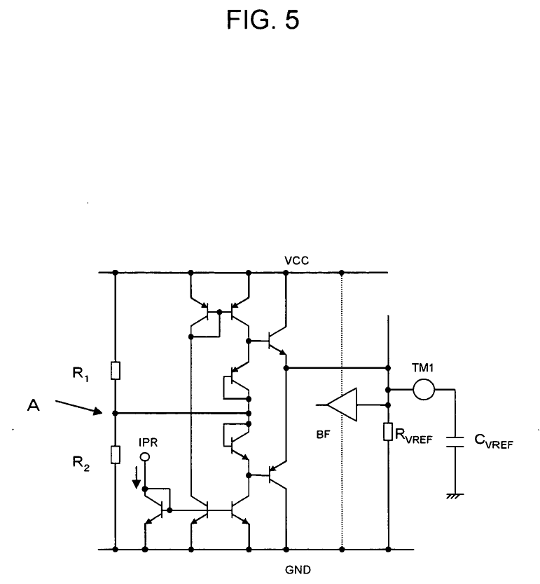

### DESCRIPTION OF THE EXEMPLARY EMBODIMENTS

Embodiments of the present invention will be described below with reference to the drawings.

### First Embodiment

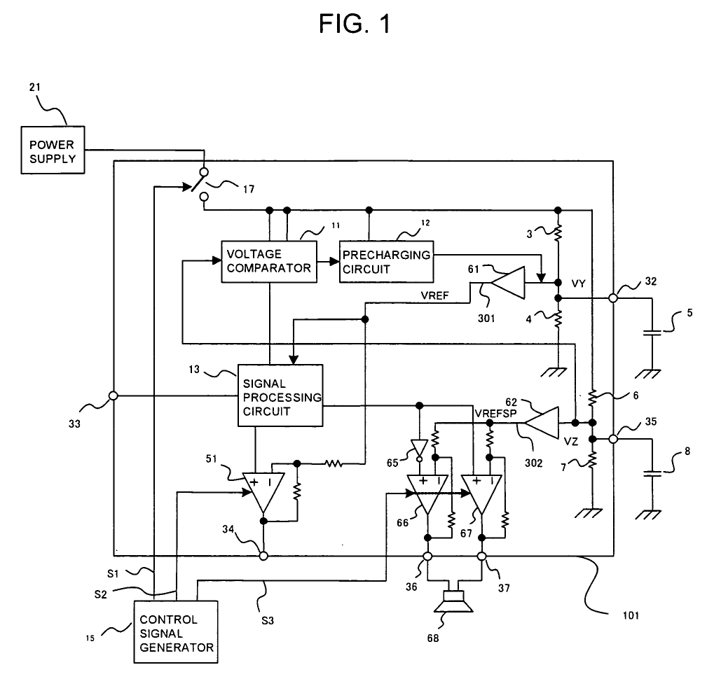

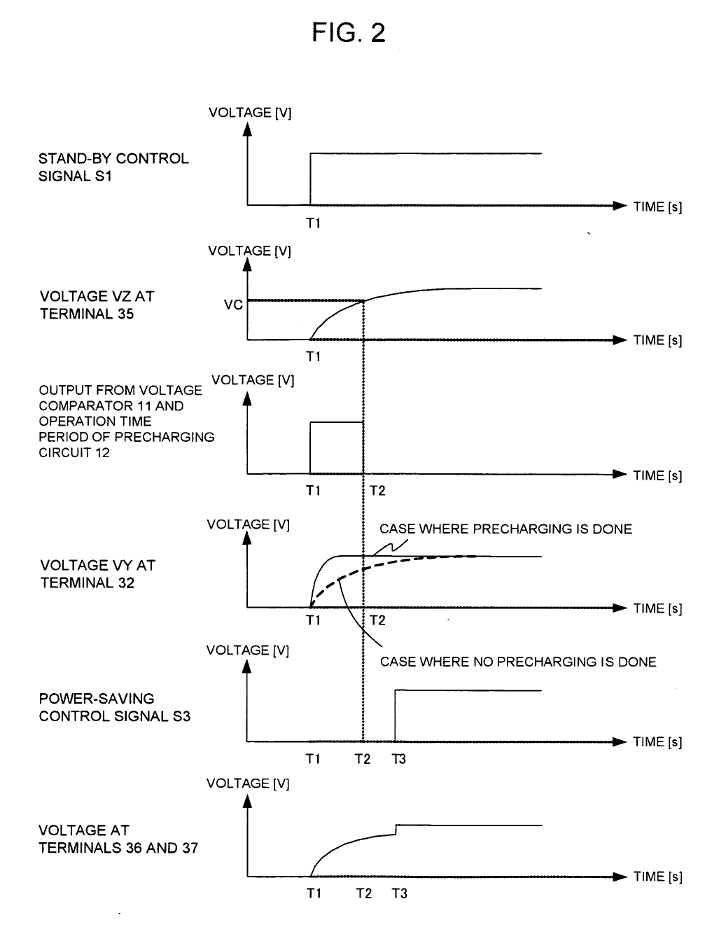

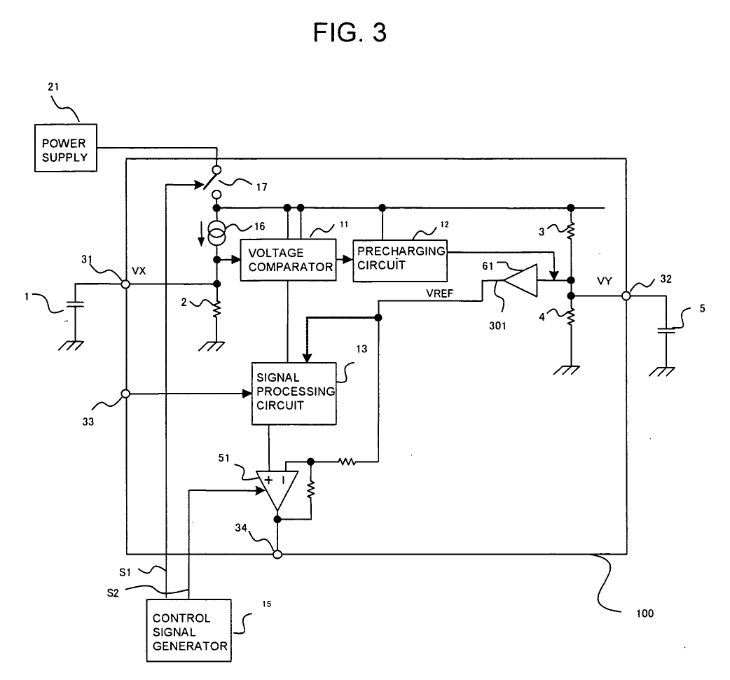

A semiconductor integrated circuit according to a first embodiment of the invention will be described with reference to FIGS. 1 and 2. Incidentally, the same components as those of FIG. 3 described in the conventional example are indicated by using the same reference numerals.

In FIG. 1, reference numeral 101 denotes a semiconductor integrated circuit. Reference numeral 3 denotes a first resistor which divides a power supply voltage to generate a reference voltage VREF. Reference numeral 4 denotes a second resistor which divides the power supply voltage to generate the reference voltage VREF. Reference numeral 5 denotes an external capacitor for stabilizing the reference voltage. Reference numeral 6 denotes a third resistor which divides the power supply voltage to generate a reference voltage VREFSP for a speaker. Reference numeral 7 denotes a fourth resistor which divides the power supply voltage to generate the reference voltage VREFSP for the speaker. Reference numeral 8 denotes an external capacitor for stabilizing the reference voltage for the speaker. Reference numeral 32 denotes a terminal to which the capacitor 5 for stabilizing the reference voltage is connected. Reference numeral 35 denotes a terminal to which the capacitor 8 for stabilizing the reference voltage for the speaker is connected. Reference numeral 11 denotes a voltage comparator which compares a voltage at a terminal 31 and a given voltage and outputs a low-level or high-level signal according to comparison results. Reference numeral 12 denotes a precharging circuit which is turned on or off with the low-level or high-level signal outputted from the voltage comparator 11. Reference numeral 13 denotes a signal processing circuit which operates based on the reference voltage VREF. Reference numeral 17 denotes a standby control switch. Reference numeral 21 denotes a power supply from the outside. Reference numeral 33 denotes a voice signal input terminal. Reference numeral 34 denotes a voice signal output terminal. Reference numeral 51 denotes an amplifier for outputting voice signals which operates based on the reference voltage VREF. Reference numeral 61 denotes a buffer which feeds the reference voltages VREF to the amplifier 51 for outputting voice signals and the signal processing circuit 13 (which correspond to a first internal circuit) in the semiconductor integrated circuit 101. Reference numeral 65 denotes an inverter which inverts an output signal from the signal processing circuit 13. Reference numeral 66 denotes a first output amplifier for driving the speaker which receives an output signal from the inverter 65 and the reference voltage VREFSP for the speaker. Reference numeral 67 denotes a second output amplifier for driving the speaker which receives an output signal from the signal processing circuit 13 and the reference voltage VREFSP for the speaker. Reference numeral 62 denotes a buffer which feeds the reference voltages VREFSP for the speaker to the first and second output amplifiers 66 and 67 in the semiconductor integrated circuit 101. Reference numeral 36 denotes a positive-phase output terminal through which an output signal is sent to the speaker. Reference numeral 37 denotes a negative-phase output terminal through which an output signal is sent to the speaker. Reference numeral 68 denotes the speaker which is provided outside and which is connected between the positive-phase output terminal 36 and the negative-phase output terminal 37. Reference numeral 301 denotes an interconnection for use in feeding the reference voltage VREF outputted from the buffer 61 which receives a voltage (reference voltage) divided by the first and second resistors 3 and 4. Reference numeral 302 denotes an interconnection for use in feeding the reference voltage VREFSP for the speaker outputted from the buffer 62 which receives a voltage (reference voltage for the speaker) divided by the third and fourth resistors 6 and 7. Reference numeral 15 denotes a control signal generator which externally controls the standby control switch 17 and the output amplifiers 51, 66, and 67 by using low-level or high-level signals. Reference alphanumeric S1 denotes a standby control signal outputted from the control signal generator 15 and used for controlling the standby control switch 17. Reference alphanumeric S2 denotes a power-saving control signal outputted from the control signal generator 15 and used for controlling the output amplifier 51. Reference alphanumeric S3 denotes a power-saving control signal outputted from the control signal generator 15 and used for controlling the output amplifiers 66 and 67.

FIG. 2 is a graph showing variations in voltage at the individual terminals of FIG. 1.

The operation of the semiconductor integrated circuit having such a configuration will be described below with reference to FIGS. 1 and 2.

Initially, the power supply 21 is turned on.

Then the switch 17 is closed with a standby control signal S1 at a time T1 and the power supply 21 supplies power supply voltages to the individual elements in the semiconductor integrated circuit 101.

As a result, as can be seen from the curve shown in FIG. 2, a voltage VZ at the terminal 35 (to which the capacitor 8 for stabilizing reference voltage for the speaker is connected) rises gradually from the time T1 based on a time constant determined by the capacitor 8 for stabilizing reference voltage for the speaker and the resistors 6 and 7. The initial value of the voltage VZ at the terminal 35 is 0 V. Incidentally, a time constant represented by letter τ is a value having the dimension of time which is determined by the resistance value of a resistor and the capacitance value of a capacitor; at about 3 τ to 5 τ, voltage becomes stable. For example, in this embodiment, the time constant τ is expressed by the following equation:
τ=C8*R6*R7/(R6+R7)
where C8 is the capacitance value of the capacitor 8, R6 is the resistance value of the resistor 6, and R7 is the resistance value of the resistor 7.

The voltage comparator 11 compares a voltage VZ at the connecting terminal 35 of the capacitor 8 for stabilizing reference voltage for the speaker and a given voltage VC. As a result of the comparison,

when the voltage VZ at the terminal 35≦the voltage VC, an output from the voltage comparator 11 is at a high level, and

when the voltage VZ at the terminal 35>the voltage VC, an output from the voltage comparator 11 is at a low level.

That is, the high level is maintained for a time period from the time T1 when the standby control signal S1 has been brought to the high level to a time T2 when the voltage VZ at the terminal 35 exceeds the voltage VC.

Next, the precharging circuit 12 is controlled with the output voltage from the voltage comparator 11 such that when the high level is brought about, the precharging circuit 12 is turned on (is operated) and when the low level is brought about, the precharging circuit 12 is turned off (is not operated). Therefore the precharging circuit 12 is turned on at the time T1 and is turned off at the time T2.

Then, for the time period (T2−T1) during which the precharging circuit 12 is in the ON state, the capacitor 5 for stabilizing reference voltage is precharged, the capacitor 5 is charged rapidly, and as shown by the solid line, a voltage VY at the terminal 32 is rapidly raised to a stable voltage VS. Therefore, as shown by the broken line, the voltage VY (=the reference voltage VREF) can be quickly brought to the stable state as compared with the case where precharging is not done. The time period during which the precharging circuit 12 is in the ON state (T2−T1) can be arbitrarily determined by changing the voltage value VC subjected to the comparison at the voltage comparator 11.

The signal processing circuit 13 and the output amplifier 51 operate based on the reference voltage VREF. Because of this, after the precharging circuit 12 has been turned off, that is, by turning on the output amplifier 51 with a power-saving control signal S2 outputted from the control signal generator 15 at a time T3 subsequent to the time T2, a voice signal can be outputted from the output amplifier 51.

When the output amplifier 51 has been turned out with such timing without the use of the precharging circuit, the reference voltage VREF is not stabilized as can be seen from variations in the voltage VY at the terminal brought about when precharging has not been done (shown by the broken line), and therefore pop noise occurs at the output amplifier 51 at the time T3. To prevent the occurrence of pop noise, it is necessary to further delay the timing of outputting the power-saving control signal S2.

On the other hand, the use of the precharging circuit 12 makes it possible to shorten the time taken from the release of the standby state to the output of the signal. Incidentally, the time T2−T1 is set at ≦200 msec in general. The reason why the time T2−T1≦200 msec is that it is assumed that a time exceeding 200 msec brings about a feeling that a response produced during the operation of a terminal device including the integrated circuit is poor. In the case where such a precharging circuit is not provided, a time taken to stabilize the reference voltage VREF is generally 1 sec or longer.

Voltages at the positive-phase output terminal 36 and the negative-phase output terminal 37 rises gradually from the time T1 to the time T2 as in the case of the voltage at the terminal 35 but become constant because a power-saving control signal S3 changes from the low level to the high level at a time T3 and the output amplifiers 66 and 67 are turned on.

As described above, since the use of the capacitor 8 for stabilizing reference voltage for the speaker brings about the rapid stabilization of the reference voltage VREF, the precharging can be done for any given time period. As a consequence, the time of several seconds generally taken until a voice signal is outputted can be shortened within 200 msec and hence, the response of the semiconductor integrated circuit can be improved. Therefore, when the power supply is turned off or brought to the standby state at the time of the nonuse of the semiconductor integrated circuit, and then the power supply is turned on or the standby state is released as well, voice signals can be outputted without impairment of the response.

Furthermore, the connection of the input of the voltage comparator 11 to the terminal 35 to which the capacitor 8 for stabilizing reference voltage for the speaker is connected eliminates the use of the dedicated capacitor for providing precharge timing described in the conventional example and hence, and the dedicated terminal 31 is not required as well. As a result, the size of a package can be reduced, and therefore the footprint of the mounted components can be reduced.

Since the impedance of the speaker is generally low (a load of several Q), it is necessary to use a power transistor in order to drive the speaker. And further, the power W of the speaker is expressed by the following equation:
W={(V+)−(V−)}²/RSPOUT
where V+ is an output voltage at the first output amplifier 66 for driving the speaker, V− is an output voltage at the second output amplifier 67 for driving the speaker, and RSPOUT is a load on the external speaker 68; therefore the power W is in proportion to the square of the output voltage. Because of this, the deviation of mid-point potential exactly has a considerable effect on the output power of the speaker. Therefore it is essential to optimize the mid-point potential. On account of this, there is a need to generate the reference voltage VREFSP for the speaker aside from the other reference voltages VREF of the signal processing system. Hence there is a need to provide the separate terminal used for a stabilizing capacitor which generates the reference voltage VREFSP and such a terminal is shared to generate a timing signal for the precharging circuit. Accordingly, there is no need to provide a dedicated terminal for use in generating the timing signal for the precharging circuit.

As described above, in the first embodiment, the voltage comparator 11 compares a reference voltage VREFSP for the speaker and a given voltage VC and operates the precharging circuit 12 for a time period of about 200 msec at the maximum. During that time period, a voltage at the terminal 32 is of stability.

Since the precharging circuit is not connected to the terminal 35 at that time, the reference voltage VREFSP for the speaker is not yet stabilized. When the output amplifiers for driving 66 and 67 have been operated with power-saving control signals S3 outputted from the control signal generator 15 in this state, the reference voltages VREF at the inputs of the signal processing circuit 13 and the output amplifiers 66 and 67 (the plus-side inputs of the operational amplifiers) are stabilized, but the reference voltages VREFSP for the speaker at the reference voltage inputs of the output amplifiers 66 and 67 (the minus-side inputs of the operational amplifiers) are not yet stabilized. Because of this, voltages equal to the differences between the reference voltages VREF and the reference voltages VREFSP for the speaker are outputted from the positive-phase output terminal 36 which outputs a signal to the speaker and the negative-phase output terminal 37 which outputs a signal to the speaker with both the voltages having the same level.

The drive system of the external speaker 68 is a BTL drive system. In the following, the explanation of the BTL drive system will be briefly made. When a voice signal has been inputted from the voice signal input terminal 33, the voice signal is inputted to the signal processing circuit 13. The voice signal outputted from the signal processing circuit 13 passes through the inverter 65 and the output amplifier 66 and is outputted from the positive-phase output terminal 36 as a positive-phase signal. Another voice signal outputted from the signal processing circuit 13 passes through the output amplifier 67 and is outputted from the negative-phase output terminal 37 as a negative-phase signal.

As a result, to the external speaker 68, the double signals represented as (V+)−(V−) (where V+ is the voice signal outputted from the terminal 36 and V− is the voice signal outputted from the terminal 37) are outputted in the upshot. However, in a case where when no signal is supplied, the reference voltage VREF is in the stable state but the reference voltage VREFSP for the speaker is changing transiently, the same outputs as those described above are supplies from the positive-phase output terminal 36 and the negative-phase output terminal 37 (see FIG. 2). On account of this, signals represented as (V+)−(V−)=0 are outputted to the external speaker 68 in the upshot, and therefore no pop noise occurs. In contrast, when the reference voltage VREF is changing transiently, a positive-phase signal and a negative-phase signal are outputted from the positive-phase output terminal 36 and the negative-phase output terminal 37 respectively. Since the signals represented as (V+)−(V−) have a finite value, pop noise occurs. In order to eliminate such pop noise, it is important to quickly stabilize the reference voltage VREF through the use of the precharging circuit as described above.

By employing the configuration explained above, it becomes possible to use the capacitor for stabilizing reference voltage for the speaker as a capacitor for providing precharge timing and further reduce the number of components and the number of terminals, and moreover, any problem resulting from the sharing does not arise.

Incidentally, it is possible to use either inverting amplifiers or noninverting amplifiers as the output amplifier 51, the first amplifier 66 for driving the speaker, and the second amplifier 67 for driving the speaker; and besides instead of the resistors 3 and 6, current sources can also be used.

In addition, the BTL output system refers to a technique in which one monophonic signal is separated into a positive-phase signal and a negative-phase signal and both the signals are linked to each other by a resistor. By using the BTL output system, double output (quadruple power) can be taken out in theory. Therefore, when the BTL configuration is employed to fabricate a semiconductor integrated circuit, such a circuit is used for driving an audio speaker, a motor, a power supply, or the like.

### INDUSTRIAL APPLICABILITY

As described above, the present invention is directed to the semiconductor integrated circuit including the amplifiers for driving the speaker with the BTL output system in which the number of the components and the number of the terminals can be further reduced by using the capacitor for stabilizing reference voltage as a capacitor which generates a timing control signal for the control of precharging.

1. A semiconductor integrated circuit comprising:
a first internal circuit which operates based on a first reference voltage;
a second internal circuit which operates based on a second reference voltage;
a voltage comparator which compares the second reference voltage and a predetermined voltage; and
a precharging circuit which makes the first reference voltage rapidly reach a stable voltage for a time period during which the second reference voltage reaches the predetermined voltage based on the comparison results from the voltage comparator.

2. The semiconductor integrated circuit according to claim 1, wherein
the first and second reference voltages are generated by first and second reference voltage generation circuits respectively,
first and second capacitors for stabilizing reference voltage are added to the first and second reference voltage generation circuits respectively, and
the precharging circuit makes the first reference voltage rapidly reach the stable voltage by charging the first capacitor for stabilizing reference voltage through the supply of a current to the first reference voltage generation circuit.

3. The semiconductor integrated circuit according to claim 2, wherein
the first reference voltage generation circuit comprises first and second resistors which generate the first reference voltage from the junction point of the resistors by dividing a power supply voltage with the resistors connected in series with each other, the first capacitor for stabilizing reference voltage connected to the junction point of the first and second resistors, and a first buffer which supplies the first reference voltage fed from the junction point of the first and second resistors to the first internal circuit and
the second reference voltage generation circuit comprises third and fourth resistors which generate the second reference voltage from the junction point of the resistors by dividing the power supply voltage with the resistors connected in series with each other, the second capacitor for stabilizing reference voltage connected to the junction point of the third and fourth resistors, and a second buffer which supplies the second reference voltage fed from the junction point of the third and fourth resistors to the second internal circuit.

4. The semiconductor integrated circuit according to claim 1, wherein
the first internal circuit includes a signal processing circuit which processes an inputted voice signal and an amplifier for voice output which receives an output signal from the signal processing circuit and operates based on the first reference voltage and
the second internal circuit includes a BTL output-type amplifier circuit for driving a speaker which receives an output signal from the signal processing circuit and which operates based on the second reference voltage.

5. The semiconductor integrated circuit according to claim 4, wherein
the amplifier circuit for driving the speaker comprises an inverter which inverts an output signal from the signal processing circuit, a first amplifier for driving the speaker to which an output signal from the inverter and the second reference voltage are supplied, and a second amplifier for driving the speaker to which an output signal from the signal processing circuit and the second reference voltage are supplied and
the speaker is connected between the output end of the first amplifier for driving the speaker and the output end of the second amplifier for driving the speaker.
